(19) United States
(12) Patent Application Publication
(10) Pub. No.: US 2006/0025051 A1
(43) Pub. Date: Feb. 2, 2006

(54) Wire sawing apparatus

(75) Inventors: Nobuchika Noguchi, Ichinomiya-city (JP); Shinya Yoshida, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/189,552

(22) Filed: Jul. 26, 2005

(30) Foreign Application Priority Data
Jul. 29, 2004 (JP) 2004-222254

(51) Int. Cl. B24B 49/00; B28D 1/08

(52) U.S. Cl. 451/5; 125/21

(57) ABSTRACT

A wire sawing apparatus includes a plurality of cutting wires arranged in parallel with one another and caused to travel in their axial directions; a table on which a workpiece is placed and held; a moving device for vertically moving the table; and a machining-liquid feed pipe. While a machining liquid is falling from a machining-liquid feed opening of the machining-liquid feed pipe, the moving device causes the workpiece to be pressed against the traveling cutting wires, thereby cutting the workpiece. The wire sawing apparatus further includes a plurality of strip members attached to and hanging from the machining-liquid feed pipe. The strip members control the geometry of the machining liquid falling from the machining-liquid feed pipe such that the machining liquid falls substantially vertically without concentrating toward the center.

### BACKGROUND OF THE INVENTION

1. Field of the Invention

The present invention relates to a wire sawing apparatus whose wire is laid in a tensioned condition and is caused to travel in its axial direction and to be pressed against a workpiece to thereby cut the workpiece.

2. Description of the Related Art

Conventionally known wire sawing apparatus are each configured such that a plurality of wires are laid while being subjected to a predetermined tension and are caused to travel in their axial directions and to be pressed against a workpiece while machining liquid (slurry) in which abrasive grains are dispersed is dropped on the wires, thereby cutting the workpiece (refer to, for example, Japanese Patent Application Laid-Open (kokai) No. 2003-89050, claim 5).

Such a conventional wire sawing apparatus will be described with reference to the perspective view of FIG. 11. The wire sawing apparatus includes a wire 10, a pair of cylindrical rollers 11 and 12, a motor 13, a table 14, a table-moving device 15, and a machining-liquid feed pipe 16.

The wire 10 is wound around the cylindrical rollers 11 and 12 alternately and repeatedly to thereby form a plurality of cutting wires W that are laid in parallel with one another on a single plane (a plane in parallel with an X-Y plane in a coordinate system consisting of mutually orthogonal X-, Y-, and Z-axes). The motor 13 causes the roller 11 to rotate. The rotation of the roller 11 causes the cutting wires W to travel in their axial directions (in the direction of the X-axis). For simplified illustration, FIG. 11 involves only four cutting wires W.

The table 14 allows a workpiece 30; for example, a sintered body of ceramic, to be placed and held on its upper surface. The workpiece 30 is fixed on the table 14 by means of adhesive and is caused to move vertically together with the table 14. The machining-liquid feed pipe 16 is disposed above the cutting wires W such that its axis coincides with a direction (the direction of the Y-axis) perpendicularly intersecting the axes of the cutting wires W. The machining-liquid feed pipe 16 has a slit formed at its bottom. A machining liquid S is fed into the machining-liquid feed pipe 16 from an unillustrated pump and falls via the slit.

With the thus-configured wire sawing apparatus, the cutting wires W are caused to travel while the machining liquid S is caused to fall toward the cutting wires W, and, at the same time, the moving device 15 causes the workpiece 30 on the table 14 to be pressed against the cutting wires W, thereby cutting the workpiece 30.

However, as shown in the side view of FIG. 12, since the machining liquid S is viscous, the machining liquid S gradually gathers (concentrates) toward a central region in the course of falling from the slit of the machining-liquid feed pipe 16. As a result, the machining liquid S fails to directly reach the cutting wires W1 and W2 located at opposite sides of the cutting wires W and, instead, reaches these cutting wires through splashes effected by impact of fall or remaining on the workpiece 30. This has involved the following problem: particularly when machining speed is increased or the quality of the machining liquid S changes, the feed of the machining liquid S to the cutting wires W1 and W2 located at opposite sides becomes insufficient, so that the cut surfaces of the workpiece 30 cut by the cutting wires W1 and W2 become wavy; i.e., fail to become flat planes.

In order to cope with the problem, as shown in FIG. 13, the distance between the workpiece 30 and the machining-liquid feed pipe 16 as measured before the start of cutting is reduced. This allows the machining liquid S to reach all the cutting wires W. However, when the length (height) of the workpiece 30 in the direction of cutting (the direction of the Z-axis) is great, as shown in FIG. 14, the machining-liquid feed pipe 16 and the workpiece 30 abut each other during the process of cutting, resulting in a failure to cut the workpiece 30. This problem can be solved; i.e., contact between the machining-liquid feed pipe 16 and the workpiece 30 in the process of cutting can be avoided, by setting the distance between the workpiece 30 and the machining-liquid feed pipe 16 as measured before the start of cutting slightly longer than the height of the workpiece 30. However, this involves another problem of troublesome work in that the distance between the workpiece 30 and the machining-liquid feed pipe 16 as measured before the start of cutting must be adjusted every time the height of the workpiece 30 changes.

### SUMMARY OF THE INVENTION

The present invention has been achieved for solving the above problems, and a wire sawing apparatus of the present invention comprises a plurality of cutting wires laid on a single plane in a tensioned condition and in parallel with one another; running means for causing the plurality of cutting wires to travel in their respective axial directions; a table disposed under the plurality of cutting wires and allowing a workpiece to be placed and held on its upper surface; moving means for moving at least either the table having the workpiece placed and held thereon or the plurality of cutting wires in a direction intersecting the plane so as to press the workpiece against the plurality of cutting wires; and machining-liquid feed means having a machining-liquid feed opening for causing a machining liquid to fall from above the plurality of cutting wires. The wire sawing apparatus is configured such that, while the machining-liquid feed means causes the machining liquid to fall from the machining-liquid feed opening, the moving means causes the workpiece to be pressed against the plurality of traveling wires to thereby cut the workpiece. The wire sawing apparatus further comprises machining-liquid falling-geometry control means disposed between the machining-liquid feed opening of the machining-liquid feed means and the plurality of cutting wires and adapted to control the geometry (shape) of the falling machining liquid such that the machining liquid falling from the machining-liquid feed opening reaches contact positions between the workpiece and the plurality of cutting wires.

With the above configuration, the workpiece is pressed against (caused to abut) a plurality of cutting wires traveling in their axial directions to thereby be cut. During the process of cutting, by virtue of the presence of the machining-liquid falling-geometry control means, the machining liquid falling from the machining-liquid feed opening of the machining-liquid feed means reaches all the contact positions between the workpiece and the plurality of cutting wires. Accordingly, the machining liquid is stably present where the plurality of cutting wires are cutting the workpiece. As a result, cut surfaces of the workpiece become expected flat planes.

Preferably, the machining-liquid feed means comprises a tubular member whose axis extends through two particular points located substantially vertically above two arbitrary points respectively located on two cutting wires that are located at opposite ends of the plurality of cutting wires with respect to a direction perpendicularly intersecting the axes of the plurality of cutting wires on the above-mentioned plane, and which has, on its bottom as the machining-liquid feed opening, a slit-like opening extending substantially in parallel with the axis and between two positions in the vicinity of the two particular points; and a pump for feeding the machining liquid into the tubular member. Also, the machining-liquid falling-geometry control means comprises a flexible, thin plate disposed between the machining-liquid feed opening and the cutting wires and bending upon contact with the workpiece.

In this case, preferably, the flexible, thin plate has good wettability with respect to the machining liquid. The slit-like opening may be a so-called slit or a number of small holes arranged substantially linearly (arranged in such a manner as to yield a function substantially similar to that of a slit).

With the above configuration, the machining liquid is fed to the tubular member by the pump and falls from the slit-like opening provided at the bottom of the tubular member. At the stage of starting to fall, the machining liquid assumes a film-like geometry whose width is substantially equal to the distance between the opposite end cutting wires of the plurality of cutting wires (distance between two positions in the vicinity of the two particular points). The thin plate disposed between the slit-like opening and the cutting wires controls the geometry of the machining liquid in the process of falling. As a result, the machining liquid can reliably reach target positions (i.e., contact positions between the workpiece and the plurality of cutting wires). Further, the thin plate has such flexibility as to bend upon contact with the workpiece. Accordingly, even when the thin plate comes into contact with the workpiece in the process of cutting, the workpiece is free of any damage.

The machining-liquid falling-geometry control means may assume the form of at least two strip members attached to the tubular member in the vicinity of the two particular points and hanging down from the tubular member.

As mentioned previously, the machining liquid falls in a film-like form from the slit-like opening. Accordingly, the hanging strip members control the opposite edges of the film, so that the machining liquid can readily reach over a wide range. Herein, no particular limitation is imposed on the strip member, so long as the strip member has such rigidity as to be able to control the geometry of the machining liquid. The strip member includes, for example, a strip member that is very narrow and thus can substantially be called a wire member.

The machining-liquid falling-geometry control means may include a strip member attached to the tubular member such that the strip member is located between two positions in the vicinity of the two particular points and hangs down-from the tubular member.

The above configuration allows free modification of the number of and the attachment positions of the strip members, so that the geometry of the falling machining liquid can be readily controlled to a desired geometry.

In this case, the machining-liquid falling-geometry control means may include a connection member that connects lower end portions of the plurality of strip members substantially in parallel with the tubular member.

With the above configuration, the machining liquid falling from the slit-like opening is led to the connection member via the strip members and subsequently falls freely from the connection member. Accordingly, the configuration allows reduction in the distance between the workpiece and a position (connection member) where the machining liquid starts final fall, so that the machining liquid can reliably reach target positions. In the case where only the strip members are provided, discontinuity may possibly arise in the machining liquid film as a result of lack of the machining liquid in the vicinity of lower end portions of the strip members. The presence of the connection member can avoid occurrence of such discontinuity of the machining liquid film.

The machining-liquid falling-geometry control means may include a film-like member extending between two positions in the vicinity of the two particular points and hanging down from the tubular member.

The film-like member can readily control the geometry of the falling machining liquid.

Further, the machining-liquid falling-geometry control means may be provided separately from the tubular member. That is, the machining-liquid falling-geometry control means may comprise a support member disposed above the plurality of cutting wires and substantially directly below (vertically under) the slit-like opening of the tubular member and extending in parallel with the tubular member; and a flexible strip member attached to the support member, hanging down from the support member, and bending upon contact with the workpiece.

With the above configuration, the machining liquid falling from the slit-like opening of the tubular member is once captured by the support member before reaching the cutting wires, and falls further from the support member while its geometry is controlled by the strip members. Since the strip members have such flexibility as to bend upon contact with the workpiece, even when the strip members come into contact with the workpiece in the process of cutting, the workpiece is free of any damage. Thus, the configuration allows reduction in the distance between the workpiece and a position (support member) where the machining liquid starts final fall, so that the machining liquid can reliably reach target positions.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a perspective view of a wire sawing apparatus according to a first embodiment of the present invention;

FIG. 2 is a front view of the wire sawing apparatus shown in FIG. 1;

FIG. 3 is a sectional view of the wire sawing apparatus cut by a plane along line III-III of FIG. 2;

FIG. 4 is an enlarged sectional view of the machining-liquid feed pipe and its periphery shown in FIG. 1;

FIG. 5 is a view showing the condition of contact between the strip member and the workpiece shown in FIG. 1;

FIG. 6 is a partially sectional view of a wire sawing apparatus according to a second embodiment of the present invention;

FIG. 7 is a partially sectional view of a wire sawing apparatus according to a third embodiment of the present invention;

FIG. 8 is a partially sectional view of a wire sawing apparatus according to a fourth embodiment of the present invention;

FIG. 9 is a partially sectional view of a wire sawing apparatus according to a fifth embodiment of the present invention;

FIG. 10 is a partially sectional view of a wire sawing apparatus according to a sixth embodiment of the present invention;

FIG. 11 is a perspective view of a conventional wire sawing apparatus;

FIG. 12 is a partially sectional view of the conventional wire sawing apparatus;

FIG. 13 is a partially sectional view of the conventional wire sawing apparatus; and

FIG. 14 is a partially sectional view of the conventional wire sawing apparatus.

### DESCRIPTION OF THE PREFERRED EMBODIMENTS

Embodiments of the present invention will next be described in detail with reference to the drawings.

### First Embodiment

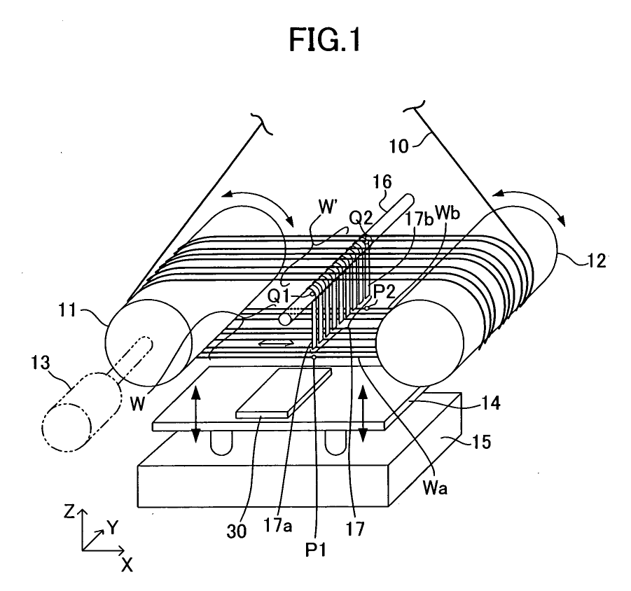

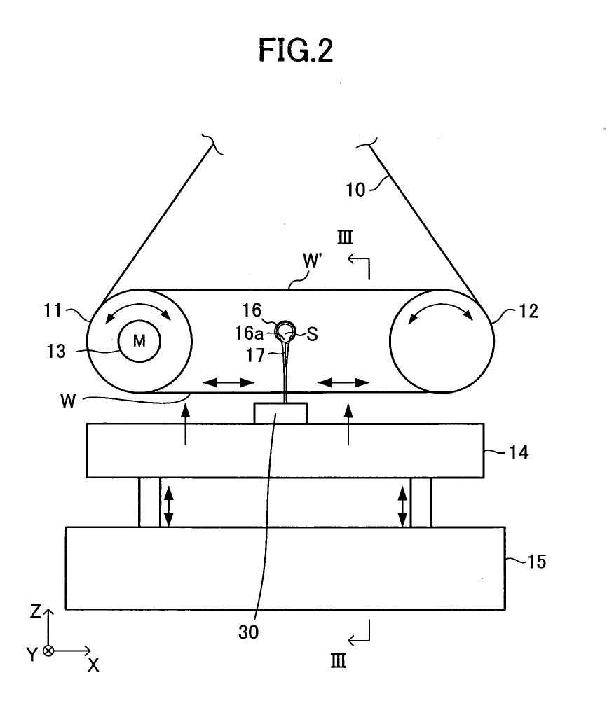

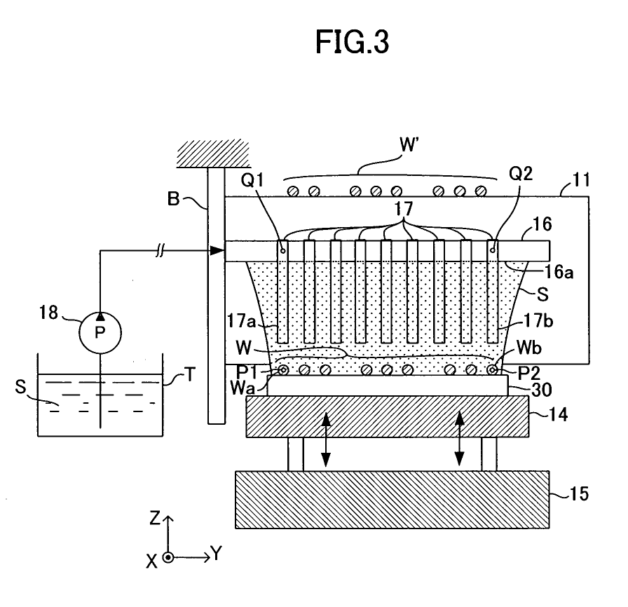

As shown in the perspective view of FIG. 1, the front view of FIG. 2, and the sectional view of FIG. 3 illustrating a wire sawing apparatus in section cut by a plane extending along line III-III of FIG. 2, a wire sawing apparatus according to a first embodiment of the present invention includes a wire 10; a pair of cylindrical rollers 11 and 12; a motor 13; a table 14; a table-moving device 15, which serves as moving means; a machining-liquid feed pipe 16, which serves as machining-liquid feed means; and strip members 17, which serve as machining-liquid falling-geometry control means.

The roller 11 is supported by the unillustrated frame of the wire sawing apparatus in such a manner as to be rotatable about its axis extending along the direction of the Y-axis in a coordinate system consisting of mutually orthogonal X-, Y-, and Z-axes. The shaft of the roller 11 is connected to the rotary shaft of the motor 13. The motor 13 causes the roller 11 to rotate about its axis alternately clockwise and counterclockwise.

The roller 12 has a shape identical with that of the roller 11. The roller 12 is supported by the unillustrated frame of the wire sawing apparatus in such a manner as to be rotatable about its axis extending along the direction of the Y-axis. The height of the roller 12 is identical with that of the roller 11.

The wire 10 is wound around the cylindrical rollers 11 and 12 alternately and repeatedly while a constant tension is applied thereto by an unillustrated tension application mechanism. The thus-wound wire 10 forms a plurality of cutting wires W that extend on a single plane (a plane in parallel with the X-Y plane) along the direction of the X-axis in a tensioned condition in parallel with one another.

With the above configuration, when the roller 11 is rotated by the motor 13, the cutting wires W travel back and forth along the direction of the axes of the cutting wires W (along the direction of the X-axis).

The table 14 is disposed under (toward the negative side along the Z-axis with respect to) the cutting wires W. The table 14 is designed such that a workpiece 30 is placed on and fixed to its upper surface by use of adhesive. The table-moving device 15 is adapted to move the table 14 in the vertical direction (in the positive and negative directions of the Z-axis). The workpiece 30 may be fixed on the table 14 in such a manner that the workpiece 30 is fixed on a predetermined jig by use of adhesive, and the jig is fixed on the table 14 so as to fix the workpiece 30 indirectly on the table 14.

The machining-liquid feed pipe 16 is, for example, a straight, tubular member (pipe or hollow nozzle) made of metal. The machining-liquid feed pipe 16 is disposed (in parallel with the X-Y plane) in a space between the cutting wires W and the wires W′, which extend above the cutting wires W. The machining-liquid feed pipe 16 is fixed to the frame (indicated by reference character B in FIG. 3) in place such that, as viewed in plane, its axis extends in a direction (the direction of the Y-axis) that intersects the axes of the cutting wires W at a predetermined angle (90 degrees in the present embodiment).

In other words, the axis of the machining-liquid feed pipe 16 extends through two particular points Q1 and Q2 located substantially vertically above two arbitrary points P1 and P2 respectively located on two cutting wires Wa and Wb that are located at opposite ends of the plurality of cutting wires W with respect to a direction perpendicularly intersecting the axes of the plurality of cutting wires W on the plane (a plane in parallel with the X-Y plane) on which the plurality of cutting wires W are laid in a tensioned condition.

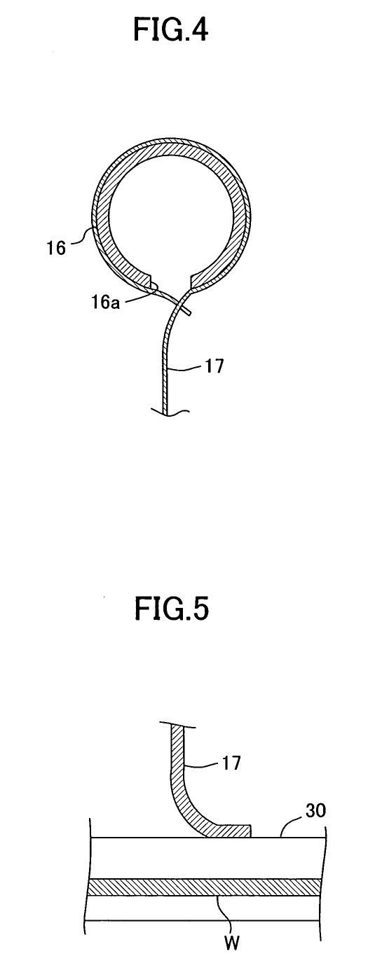

As shown in FIG. 2 and the enlarged sectional view of FIG. 4 illustrating the machining-liquid feed pipe 16 and its periphery in section cut by a plane perpendicularly intersecting the axis of the machining-liquid feed pipe 16, the machining-liquid feed pipe 16 has, on its bottom, a slit (a machining-liquid feed opening or a slit-like opening) 16a extending in parallel with the axis of the machining-liquid feed pipe 16 and between two positions in the vicinity of the two particular points Q1 and Q2. As shown in FIG. 3, a pump 18 feeds a machining liquid (slurry containing abrasive grains and having predetermined viscosity) S into the machining-liquid feed pipe 16 from a storage tank T. As a result, as shown in FIGS. 2 and 3, the machining liquid S falls from the slit 16a of the machining-liquid feed pipe 16.

As shown in FIGS. 1 and 3, a plurality of (nine in the present embodiment) strip members 17 are each formed of a narrow, strip-like, flexible, thin plate of resin. As shown in FIG. 4, the strip members 17 are each wound on the machining-liquid feed pipe 16 to thereby be attached to the machining-liquid feed pipe 16, and hang down (in the negative direction of the Z-axis) from a point right under the slit 16a of the machining-liquid feed pipe 16.

Two of the plurality of strip members 17 are attached to the machining-liquid feed pipe 16 at two positions located substantially vertically above the two opposite-end cutting wires Wa and Wb of the plurality of cutting wires W (i.e., in the vicinity of the two particular points Q1 and Q2). Hereinafter, these strip members 17 are called opposite-end strip members 17a and 17b. The remaining seven strip members 17 are attached to the machining-liquid feed pipe 16 while being substantially equally spaced (at substantially equal intervals) between the opposite-end strip members 17a and 17b. The strip members 17 have such rigidity as to be able to control the geometry of the falling machining liquid S and, as shown in FIG. 5, to bend upon contact with the workpiece 30 so as not to damage the surface of the workpiece 30.

Next, the operation of the thus-configured wire sawing apparatus will be described. The workpiece 30 to be cut by the wire sawing apparatus is, for example, a ceramic (sintered body of ceramic) and is fixed on the table 14 by use of adhesive.

Next, the motor 13 is activated, thereby causing the cutting wires W to travel back and forth along their axes (the direction of the X-axis). Also, the pump 18 is activated, thereby feeding the machining liquid S into the machining-liquid feed pipe 16. As shown in FIGS. 2 and 3, the machining liquid S falls from the machining-liquid feed pipe 16 (slit 16a). The table-moving device 15 causes the table 14 to move upward. As a result, the workpiece 30 is pressed against (caused to abut) the traveling cutting wires W and is thus cut by the cutting wires W.

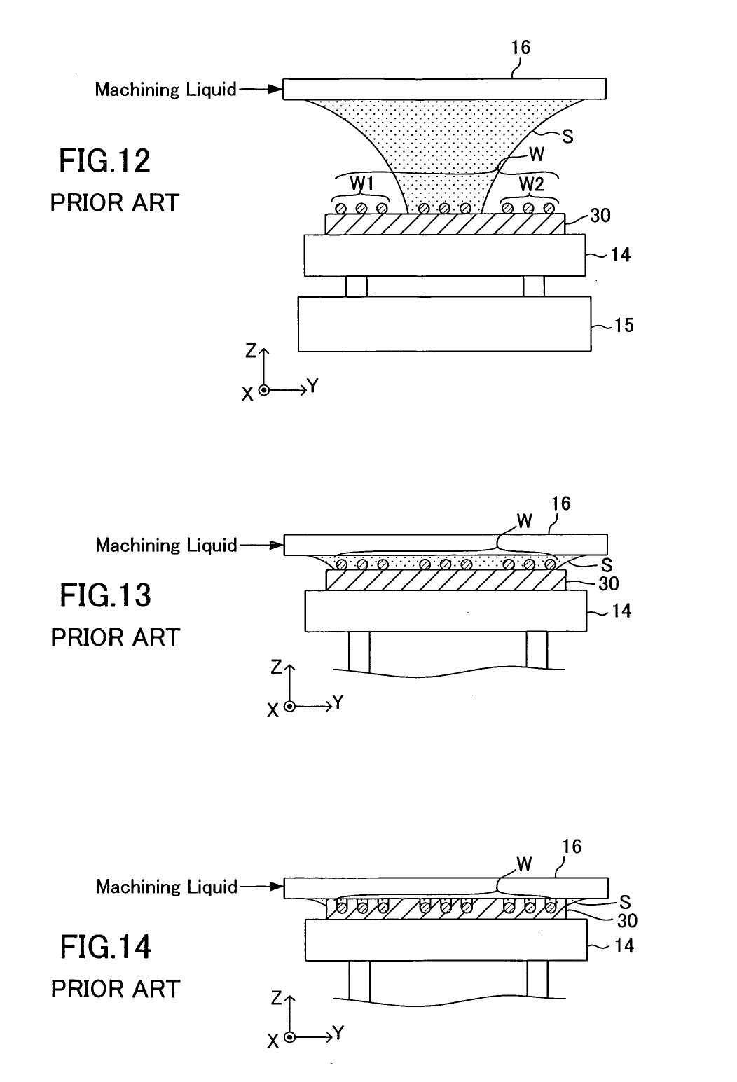

At this time, the strip members 17 control the geometry of the falling machining liquid S such that the degree of concentration of the falling machining liquid S toward a central region is (becomes) lower than that in natural fall and such that the machining liquid S reaches contact positions between the workpiece 30 and a plurality of cutting wires W. More specifically, the machining liquid S discharged from the slit 16a falls substantially vertically along the strip members 17 (while being entangled with the strip members 17). Accordingly, the machining liquid S falls while maintaining a wide width (a long length in the direction of the Y-axis) as shown in FIG. 3, without gathering toward a central region as shown in FIG. 12. Thus, the machining liquid S directly reaches contact positions between the workpiece 30 and all the cutting wires W including the two opposite-end cutting wires Wa and Wb. As a result, the machining liquid S is stably fed to (present at) all positions where the workpiece 30 is undergoing cutting by a plurality of the cutting wires W. Thus, cut surfaces of the workpiece 30 become expected flat planes.

### Second Embodiment

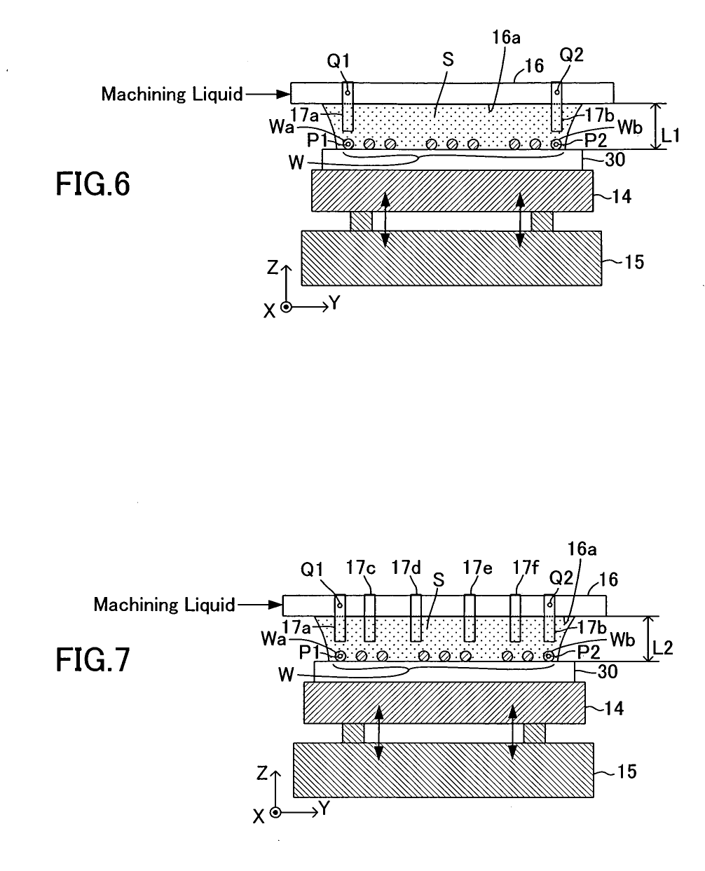

Next, a wire sawing apparatus according to a second embodiment of the present invention will be described. As shown in FIG. 6, the wire sawing apparatus according to the second embodiment differs from the wire sawing apparatus according to the first embodiment in that a distance L1 between the machining-liquid feed pipe 16 and the workpiece 30 as measured before the start of cutting is shorter than that of the wire sawing apparatus of the first embodiment and that only two strip members shorter in longitudinal length than the strip members 17 of the first embodiment are provided in the vicinity of the two particular points Q1 and Q2 (only the strip members 17a and 17b are provided).

With the wire sawing apparatus of the present embodiment, when the machining liquid S falls in a film-like condition from the machining-liquid feed pipe 16 (slit 16a), the strip members 17a and 17b hanging down vertically from the machining-liquid feed pipe 16 can direct the flow of opposite edges of the film vertically downward. As a result, by use of a few strip members, the wire sawing apparatus enables the machining liquid S to fall over a relatively wide range. Further, even when the amount of the machining-liquid S to be used is reduced, the wire sawing apparatus can readily and reliably cause the machining liquid S to reach all the cutting wires W, so that waste of the machining liquid S can be avoided.

In the present embodiment, the distance L1 between the machining-liquid feed pipe 16 and the workpiece 30 as measured before the start of cutting is shorter than that of the first embodiment, and the strip members 17a and 17b are shorter in longitudinal length than the strip members 17 of the first embodiment. However, the distance L1 and the longitudinal length of the strip members 17a and 17b can be increased as in the case of the first embodiment. In other words, the present embodiment allows the distance L1 and the length of the strip members to be determined as appropriate, so long as the machining liquid S can reach desired positions, and allows the number of strip members to be reduced to two.

### Third Embodiment

Next, a wire sawing apparatus according to a third embodiment of the present invention will be described. As shown in FIG. 7, the wire sawing apparatus according to the third embodiment is configured such that a distance L2 between the machining-liquid feed pipe 16 and the workpiece 30 as measured before the start of cutting is substantially equivalent to the distance L1 of the wire sawing apparatus of the second embodiment and such that at least one strip member (in the present embodiment, four strip members 17c, 17d, 17e, and 17f) equivalent to the strip members 17a and 17b is provided between two positions in the vicinity of the two particular points Q1 and Q2.

In other words, the wire sawing apparatus of the third embodiment is configured such that a total of six strip members 17a to 17f hang down from the slit 16a of the machining-liquid feed pipe 16. Intervals at which the strip members 17a to 17f are arranged increase toward the center of the machining-liquid feed pipe 16 with respect to the direction of the Y-axis and reduce toward end portions of the machining-liquid feed pipe 16. In other words, a plurality of strip members 17a to 17f are disposed such that arrangement density thereof increases toward two positions in the vicinity of the two particular points Q1 and Q2.

The wire sawing apparatus of the third embodiment allows free modification of the number of and the attachment positions of the strip members as needed, so that the geometry of the falling machining liquid can be readily controlled to a desired geometry.

### Fourth Embodiment

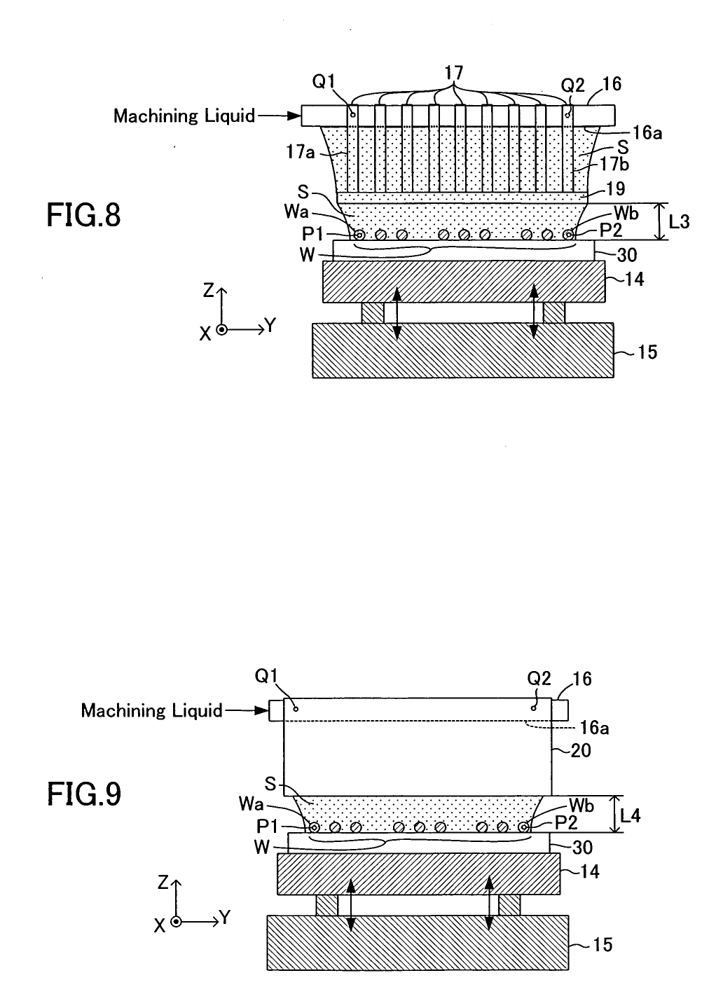

Next, a wire sawing apparatus according to a fourth embodiment of the present invention will be described. As shown in FIG. 8, the wire sawing apparatus according to the fourth embodiment differs from the wire sawing apparatus of the first embodiment only in that a connection member 19 for connecting lower end portions of the plurality of strip members 17 (end portions of the strip members 17 located toward the negative side along the Z-axis) is provided. The connection member 19 is made of a material identical with that for the strip members and is a strip member whose longitudinal direction coincides with the direction of the Y-axis.

With the above configuration, the machining liquid S falling from the slit of the machining-liquid feed pipe 16 is led to the connection member 19 via the strip members 17 and subsequently falls freely from the connection member 19. Accordingly, the configuration allows reduction in the distance between the workpiece 30 and a position (connection member 19) where the machining liquid S starts final fall, so that the machining liquid S can reliably reach target positions. In the case where only the strip members 17 are provided, discontinuity may possibly arise in the film of the machining liquid S as a result of lack of the machining liquid S in the vicinity of lower end portions of the strip members 17. By contrast, in the present embodiment, the presence of the connection member 19 can avoid occurrence of such discontinuity of the machining liquid film.

### Fifth Embodiment

Next, a wire sawing apparatus according to a fifth embodiment of the present invention will be described. As shown in FIG. 9, the wire sawing apparatus according to the fifth embodiment differs from the wire sawing apparatus according to the first embodiment only in that a film-like member 20 (a flexible, thin plate that constitutes the machining-liquid falling-geometry control means) is provided in place of the plurality of strip members 17 of the first embodiment. The film-like member 20 is made of a material identical with that for the strip members 17 and is a flexible, thin plate. The film-like member 20 is attached to the tubular member 16 in such a manner as to extend between two positions in the vicinity of the two particular points Q1 and Q2 and to hang down from the tubular member 16.

With the above configuration, the machining liquid S falling from the slit of the machining-liquid feed pipe 16 falls along the film-like member 20 and subsequently falls freely from a lower end portion of the film-like member 20. Since the film-like member 20 is made of a material having good wettability with respect to the machining liquid S, the machining liquid S falls along substantially the entire surface of the film-like member 20. Accordingly, the configuration allows reduction in a distance L4 between the workpiece 30 and a position (lower end of the film-like member 20) where the machining liquid S starts final fall, so that the machining liquid S can reliably reach target positions.

### Sixth Embodiment

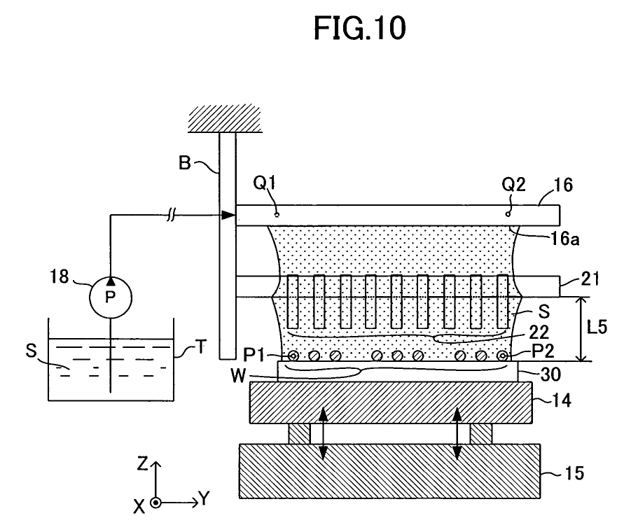

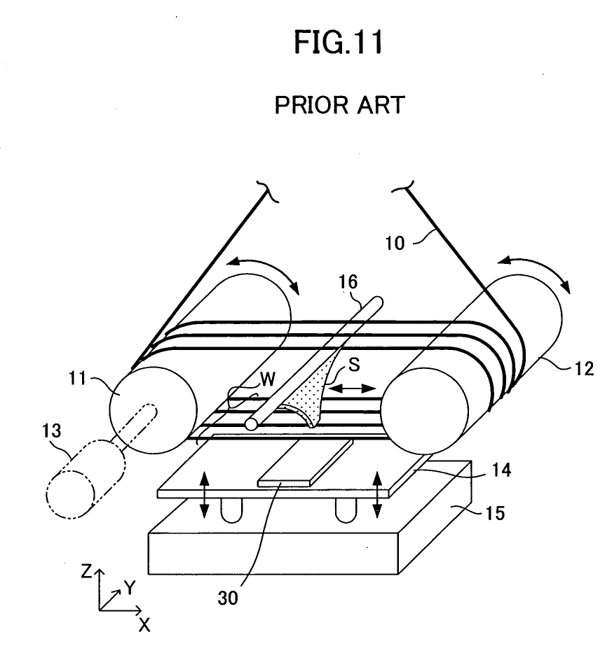

Next, a wire sawing apparatus according to a sixth embodiment of the present invention will be described. As shown in FIG. 10, the wire sawing apparatus according to the sixth embodiment differs from the wire sawing apparatus according to the first embodiment only in that, in place of a plurality strip members 17 of the first embodiment, a support member 21 separated from the tubular member 16, and a plurality of strip members 22 attached to and hanging down from the support member 21 are provided.

The support member 21 is a thin-plate member disposed above a plurality of cutting wires W (above a plane which is in parallel with the X-Y plane and on which the cutting wires W are formed) and vertically under the tubular member 16 and extending in parallel with the tubular member 16. The support member 21 is supported by the frame B. The support member 21 is coated with a material having good wettability with respect to the machining liquid S.

The strip members 22 are made of a material identical with that for the strip members 17. Accordingly, the strip members 22 have such flexibility as to bend upon contact with the workpiece 30. The strip members 22 are shorter in longitudinal length than the strip members 17 of the first embodiment. One strip member 22 is located substantially vertically under the particular point Q1, and another strip member 22 is located substantially vertically under the particular point Q2.

With the above configuration, the machining liquid S falling from the slit 16a of the tubular member 16 is once captured by the support member 21 before reaching the cutting wires W, and falls further from the support member 21 while its geometry is controlled by the strip members 22. Since the strip members 22 have such flexibility as to bend upon contact with the workpiece 30, even when the strip members 22 come into contact with the workpiece 30 in the process of cutting, the workpiece 30 is free of any damage. Thus, the configuration allows reduction in a distance L5 between the workpiece 30 and a position (support member 21) where the machining liquid starts final fall, and the strip members 22 control the geometry of the falling machining liquid S. Thus, the machining liquid S can reliably reach target positions.

As described above, with the wire sawing apparatus according to the embodiments of the present invention, the machining liquid S can be fed in a waste-free manner to all positions where the workpiece 30 is undergoing cutting by a plurality of the cutting wires W, so that cut surfaces of the workpiece 30 become expected flat planes. Further, the thin plates (machining-liquid falling-geometry control means), such as the strip members 17 and 22 and the film-like member 20, have such flexibility as to bend upon contact with the workpiece 30. Accordingly, even when the thin plates come into contact with the workpiece 30 in the process of cutting, the workpiece 30 is free of any damage. Thus, the distance between the workpiece 30 and the tubular member (slit-like opening), which is the machining-liquid feed pipe 16 (or the position where the machining-liquid starts final fall), as measured before the start of cutting can be set to near a cutting distance (height) of the workpiece 30. As a result, the machining liquid S reaches the contact positions between the workpiece 30 and the plurality of cutting wires W before it concentrates, so that, even when the amount of the machining-liquid S to be used is reduced, the machining liquid S can accurately reach target positions.

The present invention is not limited to the above embodiments, but may be modified as appropriate without departing from the scope of the invention. For example, in the above embodiments, nine cutting wires W are laid in a tensioned condition on the same plane. However, no particular limitation is imposed on the number of cutting wires W and on intervals at which the cutting wires W are arranged. In the above embodiments, the table 14 is moved upward for cutting. However, the following configuration may be employed: the table 14 (thus, the workpiece 30) is stationary, and the cutting wires W, the machining-liquid feed pipe 16, and the like are moved downward for cutting the workpiece 30. In other words, a wire sawing apparatus may be configured such that at least either the table 14 on which the workpiece 30 is placed and held or a plurality of cutting wires W are moved in a direction intersecting a plane on which the cutting wires W are laid in a tensioned condition, so as to press the workpiece 30 against the plurality of cutting wires W for cutting the workpiece 30.

In the above embodiments, the machining-liquid feed opening formed in the machining-liquid feed pipe 16 is the slit 16a. However, the machining-liquid feed opening may be a slit-like opening configured such that a number of small holes are linearly arranged so as to yield a “function of discharging the machining liquid S in a film-like form.”

What is claimed is:

1. A wire sawing apparatus comprising:
a plurality of cutting wires laid on a single plane in a tensioned condition and in parallel with one another;
running means for causing the plurality of cutting wires to travel in their respective axial directions;
a table disposed under the plurality of cutting wires and allowing a workpiece to be placed and held on its upper surface;
moving means for moving at least either the table having the workpiece placed and held thereon or the plurality of cutting wires in a direction intersecting the plane so as to press the workpiece against the plurality of cutting wires; and
machining-liquid feed means having a machining-liquid feed opening for causing a machining liquid to fall from above the plurality of cutting wires;
the wire sawing apparatus being configured such that, while the machining-liquid feed means causes the machining liquid to fall from the machining-liquid feed opening, the moving means causes the workpiece to be pressed against the plurality of traveling cutting wires to thereby cut the workpiece; and
the wire sawing apparatus further comprising machining-liquid falling-geometry control means disposed between the machining-liquid feed opening of the machining-liquid feed means and the plurality of cutting wires and adapted to control the geometry of the falling machining liquid such that the machining liquid falling from the machining-liquid feed opening reaches contact positions between the workpiece and the plurality of cutting wires

2. A wire sawing apparatus according to claim 1, wherein the machining-liquid feed means comprises:
a tubular member whose axis extends through two particular points located substantially vertically above two arbitrary points respectively located on two cutting wires that are located at opposite ends of the plurality of cutting wires with respect to a direction perpendicularly intersecting the axes of the plurality of cutting wires on the plane, and which has, on its bottom as the machining-liquid feed opening, a slit-like opening extending substantially in parallel with the axis and between two positions in the vicinity of the two particular points; and
a pump for feeding the machining liquid into the tubular member; and
the machining-liquid falling-geometry control means comprises a flexible, thin plate disposed between the machining-liquid feed opening and the cutting wires and bending upon contact with the workpiece.

3. A wire sawing apparatus according to claim 2, wherein the machining-liquid falling-geometry control means includes at least two strip members attached to the tubular member at two points in the vicinity of the two particular points and hanging down from the tubular member.

4. A wire sawing apparatus according to claim 3, wherein the machining-liquid falling-geometry control means includes a strip member attached to the tubular member such that the strip member is located between two positions in the vicinity of the two particular points and hangs down from the tubular member.

5. A wire sawing apparatus according to claim 3 wherein the machining-liquid falling-geometry control means includes a connection member that connects lower end portions of the plurality of strip members substantially in parallel with the tubular member.

6. A wire sawing apparatus according to claim 4, wherein the machining-liquid falling-geometry control means includes a connection member that connects lower end portions of the plurality of strip members substantially in parallel with the tubular member.

7. A wire sawing apparatus according to claim 2, wherein the machining-liquid falling-geometry control means includes a film-like member extending between two positions in the vicinity of the two particular points and hanging down from the tubular member.

8. A wire sawing apparatus according to claim 2, wherein the machining-liquid falling-geometry control means comprises:
a support member disposed above the plurality of cutting wires and substantially directly below the slit-like opening of the tubular member and extending in parallel with the tubular member; and
a flexible strip member attached to the support member, hanging down from the support member, and bending upon contact with the workpiece.

9. A wire sawing apparatus according to claim 4, wherein intervals at which the strip members are arranged increase toward the center of the two positions in the vicinity of the two particular points.
